(19) United States
(12) Patent Application Publication
(10) Pub. No.: US 2025/0137887 A1
(43) Pub. Date: May 1, 2025

(54) SAMPLE TRANSPORT DEVICE WITH PUMPING ELEMENT FOR AN ANALYZER

(71) Applicant: Agilent Technologies, Inc., Santa Clara, CA (US)

(72) Inventors: Blasius Nocon, Rheinstetten (DE); Thomas Ortmann, Straubenhardt/Ottenhausen (DE)

(21) Appl. No.: 18/932,291

(22) Filed: Oct. 30, 2024

(30) Foreign Application Priority Data
Oct. 31, 2023 (DE) 102023130137.3

(51) Int. Cl. G01N 1/00; G01N 30/32

(52) U.S. Cl. CPC G01N 1/00; G01N 2001/002; G01N 2030/326

(57) ABSTRACT

A sample transport device for transporting a fluidic sample, in particular for an analyzer for analyzing the fluidic sample, includes a sample receptacle for receiving and/or dispensing the fluidic sample; a moving device, in particular a robot arm, for moving the sample receptacle, and a pumping element arranged to be moved by the moving device to perform and/or trigger a pumping operation.

### CROSS-REFERENCE TO RELATED APPLICATIONS

The present application claims the benefit of German Patent Application No. DE 102023130137.3, filed on Oct. 31, 2023, which is incorporated herein by reference in its entirety.

### TECHNICAL FIELD

The present invention relates to a sample transport device for transporting a fluidic sample, in particular for an analyzer for analyzing the fluidic sample. The sample transport device has a sample receptacle, a moving device, and a pumping element that is arranged to be moved by the moving device in order to perform and/or trigger a pumping operation. Furthermore, the invention relates to a sample transport arrangement, the analyzer, and a method for operating a sample transport device.

### BACKGROUND

Analysis devices such as sample separators are intended for analyzing a sample, in particular a fluidic sample, e.g. for performing a chromatographic separation of the sample.

In an HPLC (high performance liquid chromatography) analyzer, for example, a liquid (mobile phase) is moved at a very precisely controlled flow rate (for example in the range of microliters to milliliters per minute) and at a high pressure (typically 20 to 1000 bar and beyond, currently up to 2000 bar), at which the compressibility of the liquid can be noticeable, through a so-called stationary phase (for example in a chromatographic column) in order to separate individual fractions of a sample liquid introduced into the mobile phase. After passing through the stationary phase, the separated fractions of the fluidic sample are detected in a detector. Such an HPLC system is known, for example, from EP 0,309,596 B1 of the same applicant, Agilent Technologies, Inc.

In analyzers, (fluidic) samples are usually examined, which are supplied to the actual analysis (e.g. a sample separating device) by means of an autosampler. Usually, the sample is received (e.g. from a sample container), transported (e.g. through a sample space) and dispensed (e.g. into an injection path for the analytical domain) by means of a sample receiving device, in particular a sample needle. Often, especially with a large number of samples, the sample transport is automated. In this case, it may be necessary to rinse or clean the sample needle regularly. Otherwise, the samples would contaminate each other and the quality of the analysis would decrease significantly.

FIG. 6 schematically shows a conventional sample space 200 with such a rinsing system. A robot arm 250 is moved within the sample space 200, which can transport fluidic sample by means of a sample needle. In order to perform the rinsing process, the sample needle is lowered downwards in the vertical direction (Z) and immersed in a rinsing container 240. The rinsing container 240 is coupled to a rinsing solution container 243, which contains the rinsing solution required for rinsing. However, actively driven pumping is necessary so that the rinsing solution can be provided to the rinsing container 240 for a rinsing process. This is conventionally realized by means of a motor 245 (e.g. piezo drive, electric motor), which must be provided additionally and therefore consumes a not inconsiderable amount of material costs, maintenance costs and energy costs. Furthermore, the associated infrastructure is required (electronics, cables, etc.), which also requires additional space.

### SUMMARY

There may be a need to provide a pumping operation in the context of an analyzer efficiently and with low (energy/cost) expenditure.

According to an exemplary embodiment of the present disclosure, a sample transport device (e.g. a sampler) is described for transporting a fluidic sample, in particular for an analyzer (e.g. an HPLC) for analyzing the fluidic sample, wherein the sample transport device comprises:
i) a sample receptacle (or a sample receptacle volume; e.g. a sample needle or a sample loop) for receiving and/or dispensing (or transporting) the fluidic sample,
ii) a (sample) moving device (in particular a robot arm) for moving the sample receptacle (e.g. a sample needle is moved by means of a robot arm), and
iii) a pumping element (e.g. a piston-shaped component) which is arranged to be moved by the moving device in order (simultaneously with the movement) to perform a pumping operation (or to exert a direct pumping action, in particular at least as part of a pump) and/or to trigger (or to exert an indirect pumping action, in particular to trigger such an action by moving the pumping element).

According to another exemplary embodiment of the present disclosure, a sample transport arrangement is described, comprising:
i) a sample transport device as described above, and
ii) a pumping device (e.g. a pump volume for the pumping element), which is arranged to interact directly or indirectly with the pumping element when the moving device is moved (in particular in the vertical (Z) direction) in such a way that a pumping operation is performed and/or triggered (for example, the pumping element acts as a piston in a pump volume of the pumping device).

According to a further exemplary embodiment of the present disclosure, an analyzer for analyzing a fluidic sample (for example to be injected into a mobile phase) is provided, wherein the analyzer comprises at least one sample transport device and/or a sample transport arrangement as described above.

According to another exemplary embodiment of the present disclosure, use of a (sample) moving device, in particular a robot arm, of an analyzer for performing and/or triggering a pumping operation is described.

According to another exemplary embodiment of the present disclosure, a method is described for operating a sample transportation device (e.g. as described above), the method comprising:
i) transporting a fluidic sample, in particular for an analyzer for analyzing the fluidic sample, by means of a sample receptacle (device) of the sample transport device,
ii) moving a moving device, in particular a robot arm, of the sample transport device, and thereby
iii) performing and/or triggering a pumping operation by means of a pumping element of the sample transport device.

In the context of the present application, the term “(sample) moving device” can be understood in particular to mean a component or an assembly which can execute at least one movement (in particular a rotary movement), for example in order to mechanically move another component (for example a sample needle) arranged on a movement apparatus according to the cantilever type. Alternatively or additionally, the moving device can be designed to perform at least one translational and/or rotational movement, for example to vertically raise or lower a sample receptacle (device) and/or a pumping element.

In the context of the present application, the term “pumping element” can be understood in particular to mean a component or an assembly which is configured to be associated with a pumping operation, in particular to trigger such a pumping operation or to perform it itself. In one example, the pumping element is associated with the moving device, in particular arranged/attached to it. As a result, the pumping element can be moved together (simultaneously) with the moving device (in a horizontal and/or vertical direction). In one example, the pumping element can fulfill the function of a pump piston, which is pressed into an associated pump chamber (e.g. a volume of a pumping device), thereby effecting a pumping operation. The volume of the pumping device may further be coupled to a fluid inlet and/or a fluid outlet, such that a fluid may be pumped through the volume of the pumping device by means of the pumping action. In one example, however, the pumping element itself can also have a pump volume which, when moved by the moving device, is pressed onto a pumping device, which then fulfills the piston function.

In the context of the present application, the term “fluid” is understood in particular to mean a liquid and/or a gas, optionally comprising solid particles.

In the context of the present application, the term “fluidic sample” is understood to mean in particular a medium, further in particular a liquid, which contains the actual matter to be analyzed (for example a biological sample), such as a protein solution, a pharmaceutical sample, etc.

In the context of the present application, the term “mobile phase” is understood to mean in particular a fluid, furthermore in particular a liquid, which serves as a carrier medium for transporting the fluidic sample between a fluid drive and a sample separating device. However, mobile phase can also be used in a fluid transportation device to influence the fluidic sample. For example, the mobile phase can be a solvent (e.g. organic and/or inorganic) or a solvent composition (e.g. water and ethanol).

In the context of the present application, the term “analyzer” may in particular designate a device which is capable of and configured for analyzing, in particular separating, a fluidic sample, further in particular separating it into different fractions. For example, such a sample separation can be performed by means of chromatography or electrophoresis. In an embodiment, the analyzer can be a liquid chromatography sample separating device.

In the context of the present application, the term “sample needle” can be understood in particular to mean a hollow body with a lumen or through-hole through which a fluidic sample can be passed. In particular, a fluidic sample can be introduced (e.g. sucked in) into a sample handling device and/or removed (e.g. ejected) from a sample handling device through the lumen or through-hole. A sample needle can be elongated and rotationally symmetrical and can therefore have an axis of symmetry.

According to an exemplary embodiment, the present disclosure can be based on the idea that a pumping operation can be provided efficiently and (energy/cost) favorably in the context of an analyzer if a sample transport device is provided with a moving device which is coupled not only to a sample receptacle but also to a pumping element, and wherein moving the sample receptacle by the moving device also enables the pumping element to be moved by the moving device. This allows the kinetic energy of the moving device to be used not only for handling a sample (receiving, transporting, dispensing), but also for executing/triggering a pumping operation by the pumping element at the same time. In this way, an additional pump including drive unit (see FIG. 6 above) becomes obsolete, as this function is performed by the drive of the moving device. Accordingly, material costs, energy costs and maintenance costs are saved, while at the same time less space is required.

In other words, existing drives in the sample space (autosampler) such as the motors for moving the axes of the moving device (robot arm) can also be used to drive pumping devices. This means that the previously separate drives for these pumping devices can be dispensed with. In practice, rinsing/washing pumps in particular (usually designed as peristaltic pumps) can be operated in this way. With such a configuration, only the actual pump unit or pumping element is required. The pump drive and the infrastructure required for the drive can be dispensed with.

According to an embodiment, the pumping element has an elongated part which has a preferred direction (the extension in one spatial direction is significantly greater than in another or both other spatial directions), in particular which is oriented in the vertical direction (z). This allows the pumping element to perform/trigger the pumping operation (the pumping action) directly by moving in a vertical direction (parallel to gravity) by means of the moving device. The pumping element can, for example, be designed as a rod, column or piston with a round, rectangular, triangular or polygonal cross-section. A variety of configurations are possible, but in each case a pumping effect can be generated by the movement in a vertical direction. In one example, a syringe pump/dosing pump can be realized by moving the pumping element.

According to an embodiment, the pumping element has a planar part which is arranged at an extremity of the elongate part, in particular wherein the preferred direction of the elongate part and the preferred direction of the planar part are arranged perpendicular to one another. In this example, the pumping element is shaped like a piston, so that a piston pump can be realized by moving the pumping element.

According to an embodiment, the movement that performs and/or triggers the pumping operation is a movement in the direction of gravity (z). Usually, the sample receptacle (in particular as a sample needle) is moved in a vertical direction when a sample is received/dispensed or when a rinsing process is performed. In an embodiment, the movement of the pumping element is coupled with the movement of the sample receptacle, so that the movement is also along the vertical axis. Gravity can have a supporting effect, particularly during lowering.

According to an embodiment, the pumping element is arranged to perform the pumping operation when inserted into a corresponding pumping device, e.g. in the form of a pump piston in a pump volume, so that a piston pump is provided. The pumping device can be the counterpart to the pumping element, whereby the interaction of both elements provides a pump (e.g. the aforementioned piston pump or a syringe pump). In one example, the pumping device also has an (elongated) preferred direction (along the Z-axis). The main directions of extension of the pumping element and the pumping device may be oriented (substantially) parallel to each other. While in a first example the pumping device represents the receiving element (pumping volume), in a second example the pumping device can be the element to be introduced, while the pumping element (on the moving device) is formed as the receiving element.

According to an embodiment, the pumping element is arranged to perform/trigger the pumping operation when interacting with a coupling device, in particular a sample plate. In addition to the direct pumping action of the pumping element as part of the pump, moving the pumping element can also perform or trigger pumping indirectly. A coupling device can refer to a device on which the pumping element can act (by means of a coupling) in order to trigger the pumping operation. In an exemplary embodiment, the coupling device is formed as a sample plate, i.e. a sample table on which sample containers and/or sample container carriers can be arranged.

In one example, the sample plate is formed to rotate (in particular in a horizontal plane). Such a rotation is usually driven by a motor, but the movement of a pumping element (and coupling with the sample plate) can also cause such a rotation. The rotational movement can perform a pumping operation via a further coupling (e.g. motor rotation) with the pumping device.

According to an embodiment, the sample transport device further comprises: at least one drive (e.g. an electric motor), which is coupled to the moving device and is arranged to move the moving device in the vertical (Z-axis) and/or horizontal (X, Y plane) direction. Such drives, e.g. for robot arms/sample arms, are known and established in the field of analyzers. This technology can therefore be used directly and robustly. Advantageously, this drive can (essentially) move the pumping element without additional energy input. In an exemplary embodiment, the Z-drive of the robotics is used to drive a piston pump.

According to an embodiment, the pumping element is arranged in such a way that a pressure action and/or a pump action by the pumping element is (essentially) parallel to the direction of gravity (z). As already described above, such a movement can be coupled particularly efficiently with the movement of the moving device with respect to the sample needle. In an embodiment, the pumping element is pressed into the pumping device (its receiving volume) in order to provide the pumping action.

According to an embodiment, the pumping element has at least one of the following materials: Plastic, metal, ceramic. Based on the desired application, different established and reliable materials may be preferred.

According to one embodiment, the sample receptacle has a needle arrangement, in particular wherein the needle arrangement has a sample needle with a lumen for passing fluidic sample through. In another embodiment, the sample receptacle is formed as a sample loop.

According to an embodiment, the pumping device has a pump volume which is arranged in such a way that the pumping element can be at least partially inserted into the pump volume in order to thereby perform the pumping operation, in particular as a piston pump or syringe pump. This makes it possible to temporarily provide a pump without having to provide an additional pump or an associated drive. In another example, the pumping element has the pump volume into which the pumping device is inserted during the pumping operation. By means of movement by the moving device, the pumping element can be moved into or out of the pump volume two or more times in order to perform several pumping operations in succession.

According to an embodiment, the arrangement further comprises: a rinsing device which is arranged to at least partially receive the sample receptacle for a rinsing process. According to an embodiment, the rinsing device is coupled to the pumping device, in particular fluidically, in such a way that the pumping operation provides a fluid, in particular a rinsing solution, to the rinsing device. In other words, for example, a sample needle can be inserted into an (elongated) rinsing volume. Rinsing solution is then actively pumped into the rinsing volume in order to perform a rinsing process.

According to an embodiment, the arrangement further comprises: a coupling device, in particular a rotatable sample plate, and a pump coupling which couples the coupling device to the pumping device. According to an embodiment, the sample transport arrangement is arranged in such a way that the pumping element activates the coupling device, in particular rotates it, and triggers the pumping operation in the pumping device by means of the pump coupling.

According to an embodiment, the arrangement further comprises: a spring element which is arranged to apply a tension to the pumping element. The spring element can, for example, advantageously cause the pumping element to be biased during movement (pressing down) into the pumping device. The pumping element can then return to the starting position automatically when the bias is released. This can make the described application more flexible.

According to an embodiment, the sample transport arrangement is formed as a sample (treatment) space, in particular a sampler/(auto) sampler. This allows the described sample transport device to be integrated directly into established and widely used systems.

According to an embodiment, the method further comprises: moving the moving device, in particular in a vertical direction (z), to perform an action; and simultaneously performing and/or triggering the pumping operation, wherein the pumping operation is associated with the action.

According to one embodiment, the action comprises rinsing, in particular rinsing of the sample receiving device. This illustrative embodiment has already been described above and is also shown in FIG. 1 to FIG. 4. In addition to rinsing, however, many other actions can also be performed which are coupled with a movement of the moving device and thus also enable the pumping element (and associated pumping) to be moved. In one embodiment, the action relates to the rinsing of a needle seat (into which the sample device injects the sample received). The pumping operation can direct/flow rinsing solution to the needle seat in an analogous manner.

According to one embodiment, the pumping element is moved into a pump volume, in particular as a piston pump/syringe pump/dosing pump, in such a way that the pumping operation is performed.

According to another embodiment, the pumping element is moved to a coupling element in such a way that the pumping operation is triggered by means of the coupling element, in particular where the coupling element has a, in particular rotatable, sample plate. In a further embodiment, the drive for rotating the sample plate is also used to drive the rinsing pump, whereby the drives (and electrical connections) of the existing peristaltic pumps become obsolete.

According to one embodiment, the present disclosure makes it possible to dispense with the previously separate drives of pumping devices. In implementations, rinsing/washing pumps in particular (usually designed as peristaltic pumps) can be operated in this way.

In one embodiment, an additional rinsing pump (see FIG. 6) can be replaced by a simple piston pump, in particular a syringe pump. This syringe pump can be mounted vertically to the Z-axis of the sample arm. It is driven by moving the sample arm in the Z direction, whereby the piston is mechanically coupled to the sample arm at this time. If the arm is moved upwards, (rinsing) liquid can be received into the piston chamber. The liquid is pumped into the system by lowering the sample arm. A suitable valve configuration, e.g. consisting of two non-return valves downstream of the pump inlet/outlet, is also advantageous for this purpose. The pump can be coupled to the sample arm, e.g. by means of a suitable gripping device.

According to an embodiment, the analyzer is formed as a sample separating device. According to an embodiment, the analyzer has a fluid drive for driving a mobile phase and a fluidic sample injected into the mobile phase. According to an embodiment, the analyzer has a sample separating device for separating the fluidic sample injected into the mobile phase. According to an embodiment, the analyzer is configured to analyze at least one physical, chemical and/or biological parameter of the fluidic sample. According to an embodiment, the analyzer is configured as a sample separating device for separating the fluidic sample.

In the context of the present application, the term “sample separating device” can be understood in particular to mean a device for analyzing a fluidic sample, in particular into different fractions. For this purpose, components of the fluidic sample can first be adsorbed on the sample separating device and then desorbed separately (in particular fraction by fraction). For example, such a sample separating device can be designed as a chromatographic separation column.

According to an embodiment, the analyzer is a chromatography device, in particular a liquid chromatography device, a gas chromatography device, an SFC (supercritical fluid chromatography) device or an HPLC (high performance liquid chromatography) device.

According to an embodiment, the analyzer is configured as a microfluidic device. According to an embodiment, the analyzer is configured as a nanofluidic device.

According to an embodiment, the sample separating device is formed as a chromatographic separation device, in particular as a chromatographic separation column.

According to an embodiment, the fluid drive is configured to drive the mobile phase and the fluidic sample under high pressure.

According to one embodiment, the fluid drive is configured to drive the mobile phase and the fluidic sample at a pressure of at least 500 bar, in particular at least 1000 bar, and further in particular at least 1200 bar.

According to an embodiment, the analyzer has a detector for detecting the analyzed, in particular separated, fluidic sample.

According to an embodiment, the analyzer has a fractionator for fractionating separate fractions of the fluidic sample.

The analyzer can be a microfluidic meter, a life science device, a liquid chromatography device, a gas chromatography device, an HPLC (High Performance Liquid Chromatography) device, a UHPLC (Ultra High Performance Liquid Chromatography) device, or an SFC (supercritical fluid chromatography) device. However, many other applications are possible.

According to an embodiment, the sample separating device can be designed as a chromatographic separation device, in particular as a chromatographic separation column. In the case of chromatographic separation, the chromatographic separation column can be provided with an adsorption medium. The fluidic sample can be retained on this medium and only subsequently released fraction by fraction in the presence of a specific solvent composition, thereby separating the sample into its fractions.

A pump system for conveying fluid can, for example, be arranged to convey the fluid or the mobile phase through the system at a high pressure, for example several 100 bar up to 1000 bar and more.

The analyzer may have a sample injector for introducing the sample into the fluidic separation path. Such a sample injector can have a sample or injection needle that can be coupled to a needle seat in a corresponding fluid path, whereby the sample needle can be moved out of this needle seat in order to take up sample. After the sample needle has been reinserted into the needle seat, the sample can be located in a fluid path which can be switched into the separation path of the system, for example by switching a valve. In another embodiment of the present disclosure, a sample injector or sampler can be used with a sample needle that is operated without a needle seat.

According to an embodiment, the needle arrangement can have a sample receiving volume fluidically coupled to the sample needle, in particular a sample loop. In particular, this can be understood as a capillary piece in the interior of which a receiving volume is formed for receiving a defined quantity of fluidic sample.

The analyzer can have a fraction collector for collecting the separated components. Such a fraction collector can, for example, feed the various components of the separated sample into different liquid containers. However, the analyzed sample can also be fed into a discharge container.

The analyzer may include a detector for detecting the separated components. Such a detector can generate a signal which can be observed and/or recorded and which is indicative of the presence and amount of the sample components in the fluid flowing through the system.

Other objects and many of the attendant advantages of embodiments of the present disclosure will be readily appreciated and become better understood by reference to the following more detailed description of embodiments in connection with the accompanied drawings. Features that are substantially or functionally equal or similar will be referred to by the same reference signs.

### BRIEF DESCRIPTION OF THE DRAWINGS

Other objectives and many of the attendant advantages of embodiments of the present disclosure will become readily perceived and better understood with reference to the following more detailed specification of embodiments in connection with the accompanying drawings. Features which are substantially or functionally the same or similar are designated by the same reference signs. The illustrations in the drawings are schematic.

FIG. 1 shows an analyzer configured as a chromatography device, according to an exemplary embodiment of the present disclosure.

FIG. 2 shows a sample transport arrangement according to an exemplary embodiment of the present disclosure.

FIG. 3A is a top view of a sample transport arrangement, according to an exemplary embodiment of the present disclosure.

FIG. 3B is a side view of the sample transport arrangement shown in FIG. 3A, in a different position.

FIG. 4A is a top view of the sample transport arrangement shown in FIG. 3A, in a another, different position.

FIG. 4B is a side view of the sample transport arrangement shown in FIG. 3A, in a another, different position.

FIG. 4C is a side view of the sample transport arrangement shown in FIG. 3A, in a another, different position.

FIG. 4D is a side view of the sample transport arrangement shown in FIG. 3A, in a another, different position.

FIG. 5 shows schematically a triggering of a pumping operation in a sample transport arrangement, according to an exemplary embodiment of the present disclosure.

FIG. 6 schematically shows a conventional sample space with rinsing of the sample needle.

### DETAILED DESCRIPTION

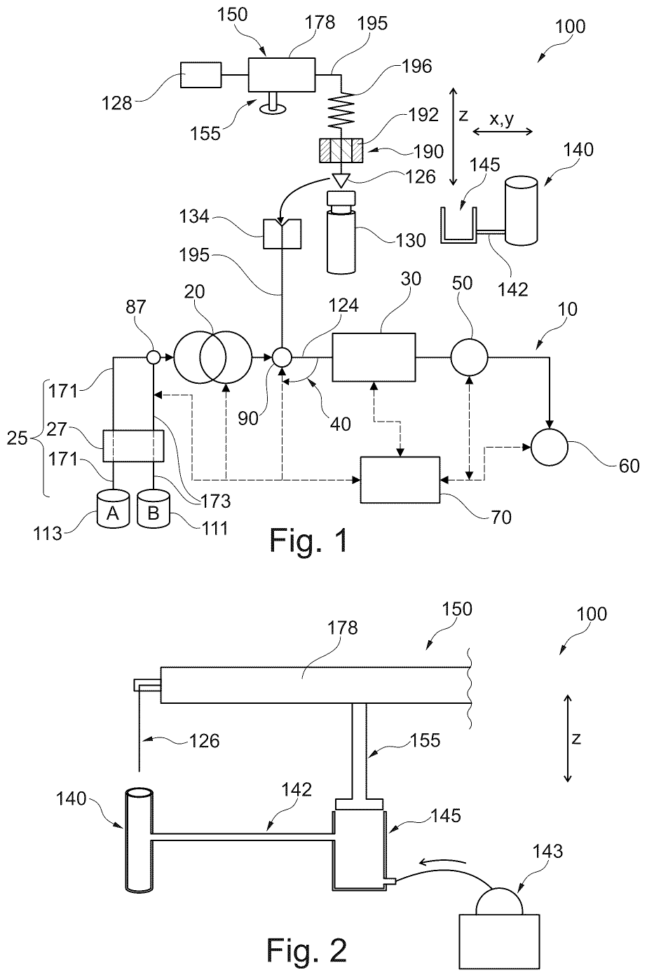

FIG. 1 shows the basic structure of an HPLC system as an example of an analyzer 10 designed as a sample separating device according to an exemplary embodiment of the present disclosure, such as can be used for liquid chromatography. A fluid delivery device or fluid drive 20, supplied with solvent from a supply device 25, drives a mobile phase through a sample separating device 30 (such as a chromatographic column) containing a stationary phase. The supply device 25 comprises a first fluid component source 113 for providing a first fluid or solvent component A (for example, water) and a second fluid component source 111 for providing another second fluid or solvent component B (for example, an organic solvent). An optional degasser 27 can degas the solvents provided by means of the first fluid component source 113 and by means of the second fluid component source 111 before they are supplied to the fluid drive 20. A sample delivery unit, which may also be referred to as an injector 40, is disposed between the fluid drive 20 and the sample separating device 30 to initially receive a sample fluid or fluidic sample from a sample container 130 into a sample receiving volume 196 in an injector path 195 (shown only schematically), and subsequently introduce it into a fluidic separation path 124 between the fluid drive 20 and the sample separating device 30 by switching an injection valve 90 of the injector 40. Fluidic sample can be received from the sample container 130 in particular by moving a sample needle 126 out of a needle seat/sample seat 134 and into the sample container 130, sucking fluidic sample from the sample container 130 through the sample needle 126 into the sample receiving volume 196 by means of a fluid conveying device designed as a metering device, and then moving the sample needle 126 back into the needle seat 134.

The stationary phase of the sample separating device 30 is intended to separate components of the sample. A detector 50, which may have a flow cell, detects separated components of the sample. A fractionation device or fractionator 60 can be provided to dispense separated components of the sample into containers provided for this purpose. Liquids that are no longer required can be discharged into a discharge container or a waste line.

While a fluid path between the fluid drive 20 and the sample separating device 30 is typically under high pressure, the sample fluid under normal pressure is first introduced into an area separate from the fluid path, namely the sample loop or sample receiving volume 196 of the sample introduction unit or injector 40. The sample liquid is then introduced into the high-pressure separation path 124. A sample loop as a sample receiving volume 196 can be understood as a section of a fluid line which is formed to take up or temporarily store a predetermined quantity of fluidic sample. In an embodiment, even before the sample fluid in the sample receiving volume 196, which is initially under normal pressure, is switched into the high-pressure separation path 124, the content of the sample receiving volume 196 is brought to the system pressure of the analyzer 10, which is formed as an HPLC, by means of a metering device in the form of the fluid delivery device. A control device 70 controls the individual components 20, 25, 30, 40, 50, 60, 90, etc., of the analyzer 10.

FIG. 1 shows two supply lines 171, 173, each of which is fluidically coupled to a respective one of the two solvent containers designated as fluid component sources 113, 111 for providing a respective one of the fluids or solvent components A and B, respectively. The respective fluid or the respective solvent component A or B is conveyed through the respective supply line 171 or 173, through the degasser 27 to a proportioning valve 87 as a proportioning device, at which the fluids or solvent components A or B from the supply lines 171, 173 are combined with one another. The fluid packages from the supply lines 171, 173 thus flow together at the proportioning valve 87, forming a homogeneous solvent composition. The latter is then fed to the fluid drive 20.

During operation of the analyzer 10, and in particular the injector 40, the injection valve 90 is switched by the control device 70 to inject a fluidic sample from the sample receiving volume 196 into a mobile phase in the separation path 124 between the fluid drive 20 and the sample separating device 30 of the analyzer 10. This switching of the injection valve 90 is performed to effect relative movement between a first valve body (which may be a stator at rest with respect to a laboratory system) and a second valve body (which may be a rotor rotatable with respect to the laboratory system) of the injection valve 90. The first valve body may be provided with a plurality of ports and optionally with one or more groove-shaped connecting structures. The second valve body, on the other hand, may be provided with several groove-shaped connecting structures in order to thereby selectively fluidically couple or decouple respective ones of the ports of the first valve body depending on a respective relative orientation between the first valve body and the second valve body by means of the at least one connecting structure of the second valve body. Illustratively, in certain switching states of the injection valve 90, a respective groove-shaped connecting structure of the second valve body can fluidically connect two (or more) of the ports of the first valve body to each other and form a fluidic decoupling between other of the ports of the first valve body. In this way, the individual components of the sample separating device 90 can be brought into an adjustable fluidic (decoupling) coupling state with one another depending on a respective operating state of the injector 40.

The analyzer 10 is also coupled to or includes a sample transport arrangement 100. In this example, the sample transport arrangement 100 is formed as a sample space (sampler). The fluidic samples are stored there in sample containers 130. A sample transport device 150 is provided in the sample space, which is movable within the sample space as an active device by means of a drive, which is implemented, for example, as an electric motor (drive 128). In this way, automated removal and transportation of fluidic samples from the sample containers 130 is possible.

The sample transport device 150 is arranged for transporting the fluidic sample and comprises: a sample receptacle 126 for receiving and/or dispensing the fluidic sample. In particular, the sample receptacle 126 has a sample receptacle volume and is formed as a sample needle, which can absorb fluidic sample and store it (also during transportation). The sample transport device 150 also has a moving device 178, which is formed as a robot arm for moving the sample receptacle 126. In the example shown, the sample needle 126 is coupled to the moving device 178 and can thus be moved/displaced in the horizontal direction (XY plane) and vertical direction (Z). In addition, the sample transport device 150 has a pumping element 155, which is attached to the moving device 178 and is arranged to be moved by the moving device 178 in order to perform and/or trigger a pumping operation at the same time as the moving device 178 is moved.

The sample needle 126 is connected to a sample receiving volume 196, whereby a portion of the fluid path 195 is provided. By means of the sample needle 126, as described above, fluidic sample can be drawn from the sample container 130 into the sample receiving volume 196 and, after transportation through the sample space into the needle seat 134, can be fed into the further fluid path 195 of the analyzer 10.

The sample transport arrangement 100 additionally comprises (in particular in the sample space) a pumping device 145, which is arranged to interact directly or indirectly with the pumping element 155 when the moving device 178 is moved in such a way that the pumping operation is performed and/or triggered (shown schematically by means of the movement of the sample transport device in the Z direction). The pumping device 145 has a pumping volume (here a cavity) which is arranged in such a way that the pumping element 155 (here designed as a piston) can be inserted at least partially into the pumping volume in order to thereby perform the pumping operation (as a piston moving in the piston chamber).

The sample transport arrangement 100 further comprises a rinsing device 140, which is arranged to at least partially receive the sample receptacle 126 for a rinsing process in order to then rinse the sample needle 126. The rinsing device 140 is fluidically coupled to the pumping device 145 such that the pumping operation provides a rinsing solution to the rinsing device 140, thereby effecting the rinsing of the sample needle 126. This method is described in detail below for FIG. 2.

FIG. 2 shows in detail a sample transport arrangement 100, according to an exemplary embodiment of the present disclosure, as already described for FIG. 1, wherein the example of FIG. 2 concentrates on the rinsing process (not on the receiving/dispensing of fluidic samples as in FIG. 1). The moving device 178 (here a cantilever arm or robot arm) is coupled to a sample needle 126 as a sample receptacle and is moved in a horizontal direction such that the sample needle 126 is positioned above the rinsing device 140. In order to rinse the sample needle 126, the moving device 178 is lowered in the vertical direction (Z) so that the sample needle 126 is inserted into a receiving volume of the rinsing device 140.

For the actual rinsing, rinsing solution is now fed from a rinsing solution container 143 into the rinsing device 140. This is done conventionally by means of an additional pump (see FIG. 6). According to the present disclosure, however, this rinsing process is solved efficiently and cost-effectively without further energy consumption: the pumping element 155, which is coupled to the moving device 178 (is attached to the latter), acts as a pump piston and the lowering of the sample transport device 150 provides the necessary kinetic energy for the pumping operation. When the sample needle 126 is located above the rinsing device 140, the pumping element 155 is also positioned above the pumping device 145. If the moving device 178 is now lowered, the pumping element 155 is pressed into the pump volume of the pumping device 145 and acts like a pump piston in a pump chamber.

In other words, the movement of the sample transport device 150 simultaneously moves the pumping element 155, so that a pumping operation is performed by means of the pumping element 155. This pumping operation draws the rinsing solution from the rinsing solution container 143 and allows it to flow into the rinsing device 140, thereby actively rinsing the sample needle 126. During the rinsing process, the sample transport device 150 can be moved up/down in the Z direction several times, so that several pumping operations can be performed. The up and down movement of the sample needle 126 can be conducive to the rinsing process, for example by providing flowing fluid.

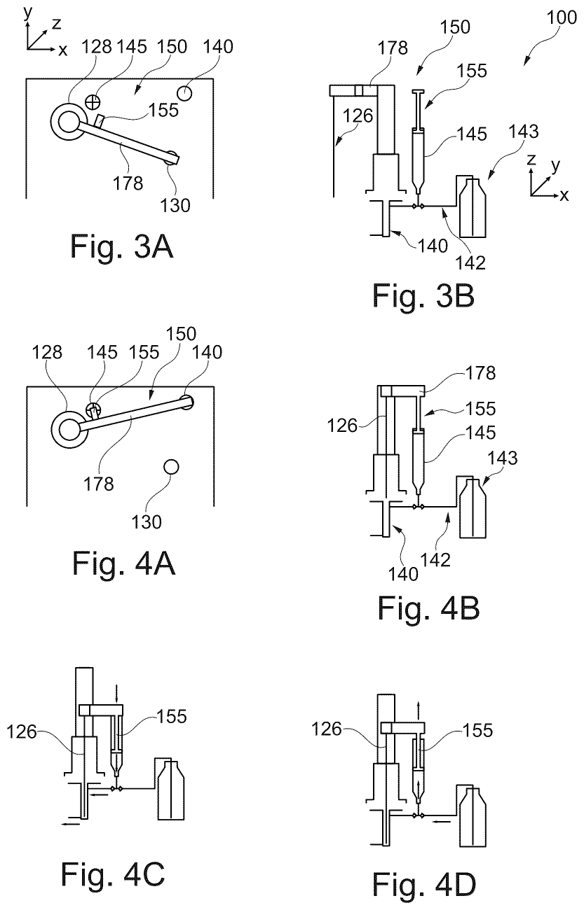

FIG. 3 and FIG. 4 show the performing of a pumping operation in a sample transport arrangement 100, according to an exemplary embodiment of the present disclosure. Here, the method described was implemented in a real sample space. By means of the drive 128, a cantilever arm 178 can be moved in a horizontal and vertical direction as a moving device. The head of the moving device 178 is coupled to a pusher device, which surrounds the sample needle 126 and is used to separate sample containers (after the sample has been aspirated). The pusher element 155 is attached to the side of the moving device 178, for example, and may be biased by means of a spring (not shown).

FIG. 3A: in this plan view (along the Z-axis) it is shown that the sample transport device 150 is positioned such that the sample needle 126 is arranged above a sample container 130 and not above a rinsing device 140. Furthermore, in this configuration, the pumping element 155 is not arranged above the pumping device 145.

FIG. 3B: in this side view, although the pumping element 155 is arranged above the pumping device 145, the pumping element 155 is uncoupled from the sample transport device 150 (in particular the moving device 178 with the sample needle 126).

FIG. 4A: in this plan view (along the Z-axis), a configuration is shown wherein the sample transport device 150 is positioned similarly to FIG. 2: the sample needle 126 is positioned above a rinsing device 140 (not above the sample container 130), and the pumping element 155 is positioned above the pumping device 145.

FIG. 4B: in conjunction with the example of FIG. 3B, the pumping element 155 can now be coupled to the sample transport device 150 so that the pumping element 155 is transported by means of the sample transport device 150.

FIG. 4C: in this configuration, the moving device 178 has been lowered in the Z-direction. The sample needle 126 is now inserted into the rinsing device 140, while the pumping element 155 is pressed into the pumping device 145 in such a way that the pumping operation described above is performed, which provides rinsing solution to the rinsing device 140. Thus, no additional devices and no additional energy are required for the pumping operation.

In other words, the robot arm 178 is positioned above the washport 140 and then the Z-axis is driven and the robot arm 178 moves down into the washport 140. During the movement, the piston pump (syringe pump) 155 is taken along by the robot arm 178 and pressed downwards. This generates a flow of solvent for rinsing in the washport 140.

FIG. 4D: After the rinsing process, the moving device 178 is moved upwards again. As a result, the sample needle 126 is transported out of the rinsing device 140 and at the same time the pumping element 155 is transported out of the pumping device 145.

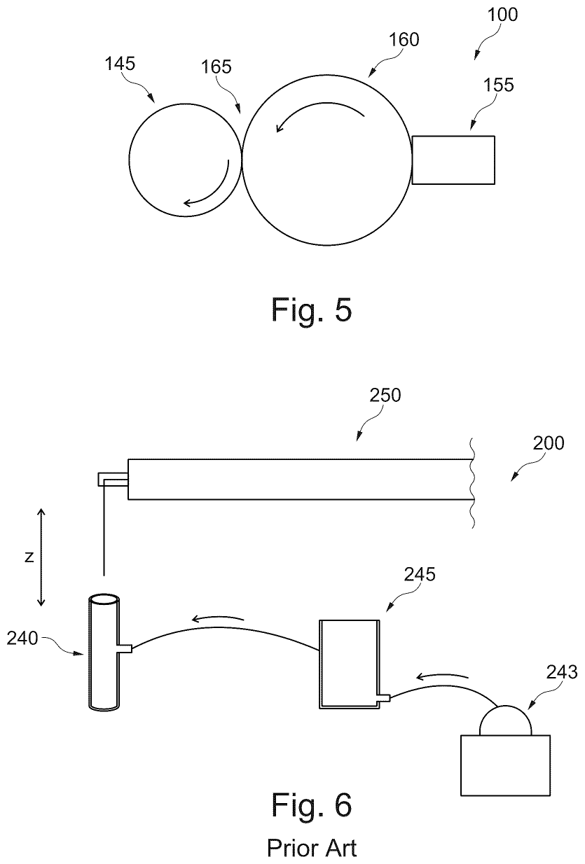

FIG. 5 schematically shows a triggering of a pumping operation in a sample transport arrangement 100, according to an exemplary embodiment of the present disclosure. Unlike in the examples of FIG. 2 to FIG. 4, the pumping operation is not performed here directly by means of the pumping element 155, but is triggered by it. In this example, the sample transport arrangement 100 has a sample plate 160, on which in turn sample containers or sample container carriers are arranged. The sample plate can also be rotated in a horizontal plane about a vertical axis. The sample plate 160 acts as a coupling device to which the pumping element 155 can be coupled (when moved by means of the sample transportation device 150). For example, the pumping element 155 can be pressed onto the sample plate 160 in such a way that a rotary movement (with or without drive of the rotary plate motor) is triggered.

The sample transport arrangement 100 also comprises a pump coupling 165 between the coupling device 160 and the pumping device 145. Here, the pumping element 155 can rotate the coupling device 160 and trigger the pumping operation in the pumping device 145 by means of the pump coupling 165.

### REFERENCE SIGNS

10 Analyzer
20 Fluid drive
25 Supply device
27 Degasser
30 Sample separating device
40 Injector
50 Detector
60 Fractionator
70 Control device
87 Proportioning valve
90 Injection valve
100 Sample transport arrangement
111 Second fluid component source
113 First fluid component source
124 Fluidic separation path
126 Sample receptacle (device), sample needle
128 Drive
134 Needle seat
140 Rinsing device, further action
142 Fluidic coupling
143 Rinsing solution container
145 Pumping device
150 Sample transport device
155 Pumping element
160 Coupling device, sample plate
165 Pump coupling
171 First supply line
173 Second supply line
178 Moving device, robot arm
190 Needle assembly
192 Needle housing
195 Injector path
196 Sample receiving volume
State of the art
200 Sample space
240 Rinsing container
243 Rinsing solution container
245 Motor
250 Robot arm

1. A sample transport device for transporting a fluidic sample for an analyzer for analyzing the fluidic sample, the sample transport device comprising:
a sample receptacle configured to receive and/or dispense the fluidic sample;
a moving device configured to move the sample receptacle; and
a pumping element configured to be moved by the moving device in order to perform and/or trigger a pumping operation.

2. The sample transport device according to claim 1, wherein the pumping element comprises an elongate part oriented in a vertical direction.

3. The sample transport device according to claim 2, wherein the pumping element comprises a planar part arranged at an extremity of the elongate part, wherein the elongate part and the planar part are arranged perpendicular to each other.

4. The sample transport device according to claim 1, wherein the pumping element is configured to be moved by the moving device in a direction of gravity in order to perform and/or trigger a pumping operation.

5. The sample transport device according to claim 1, comprising at least one of the following features:
wherein the pumping element is configured to perform the pumping operation when introduced into a corresponding pumping device;
wherein the pumping element is configured to trigger the pumping operation upon interaction with a coupling device;
wherein the pumping element is configured to trigger the pumping operation upon interaction with a sample plate.

6. The sample transport device according to claim 1, further comprising a drive coupled to the moving device and configured to move the moving device in a vertical and/or horizontal direction.

7. The sample transport device according to claim 1, further comprising at least one of the following features:
wherein the pumping element is configured such that a pressure action and/or a pumping action by the pumping element takes place substantially parallel to a direction of gravity;
wherein the pumping element comprises at least one of the following materials:
plastic; metal; ceramic;
wherein the sample receptacle comprises a needle assembly;
wherein the sample receptacle comprises a sample needle having a lumen for passing the fluidic sample therethrough.

8. A sample transport arrangement, comprising:
the sample transport device according to claim 1; and
a pumping device which, when the moving device is moved, is configured to interact directly or indirectly with the pumping element in such a way that a pumping operation is performed and/or triggered.

9. The sample transport arrangement according to claim 8, wherein the pumping device comprises a pump volume configured in such a way that the pumping element is at least partially insertable into the pump volume in order to thereby perform the pumping operation.

10. The sample transport arrangement according to claim 8, further comprising a rinsing device configured to at least partially receive the sample receptacle for a rinsing process, wherein the rinsing device is coupled to the pumping device in such a way that the pumping operation supplies a rinsing solution to the rinsing device.

11. The sample transport arrangement according to claim 8, further comprising:
a coupling device; and
a pump coupling configured to couple the coupling device to the pumping device,
wherein the sample transport arrangement is configured such that the pumping element activates the coupling device and triggers the pumping operation in the pumping device by the pump coupling.

12. The sample transport arrangement according to claim 8, further comprising a spring element configured to apply tension to the pumping element.

13. The sample transport arrangement according to claim 8, comprising at least one of the following features:
wherein the sample transport arrangement is formed as a sample treatment chamber;
wherein the sample transport arrangement is formed as an autosampler.

14. An analyzer for analyzing a fluidic sample, the analyzer comprising:
an injector configured to inject the fluidic sample into a mobile phase; and
at least one sample transport device according to claim 1.

15. The analyzer according to claim 14, further comprising at least one of the following features:
the analyzer comprises a fluid drive for driving the mobile phase and the fluidic sample injected into the mobile phase;
the analyzer comprises a fluid drive configured to drive the mobile phase and the fluidic sample with a pressure selected from the group consisting of: a pressure of at least 500 bar; a pressure of at least 1000 bar; a pressure of at least 1200 bar;
the analyzer comprises a sample separating device for separating the fluidic sample injected into the mobile phase;
the analyzer comprises a chromatographic separating device for separating the fluidic sample injected into the mobile phase;
the analyzer is configured to analyze at least one physical, chemical and/or biological parameter of the fluidic sample;
the analyzer is selected from the group consisting of: a chromatography device; a liquid chromatography device; a gas chromatography device; a supercritical fluid chromatography device; a high-performance liquid chromatography device; and an ultra-high-performance liquid chromatography device;
the analyzer is configured as a microfluidic device;
the analyzer is configured as a nanofluidic device;
the analyzer comprises a detector for detecting the separated fluidic sample;
the analyzer comprises a fractionator for fractionating separate fractions of the fluidic sample.

16. A method of operating a sample transport device, the method comprising:
transporting a fluidic sample for an analyzer for analyzing the fluidic sample, by a sample receptacle of the sample transport device;
moving a moving device of the sample transport device; and
performing and/or triggering a pumping operation by a pumping element of the sample transport device.

17. The method according to claim 16, further comprising:
moving the moving device in a vertical direction to perform an action; and
simultaneously with the moving, performing and/or triggering the pumping operation, wherein the pumping operation is associated with the action.

18. The method according to claim 17, wherein the action comprises a rinsing of the sample receptacle and/or a needle seat.

19. The method according to claim 16, comprising at least one of the following features:
wherein the pumping element is moved into a pump volume in such a way that the pumping operation is thereby performed;
wherein the pumping element is moved to a coupling element in such a way that the pumping operation is triggered by the coupling element;
wherein the pumping element is moved to a coupling element in such a way that the pumping operation is triggered by the coupling element, and the coupling element comprises a sample plate;
wherein the pumping element is moved to a coupling element in such a way that the pumping operation is triggered by the coupling element, and the coupling element comprises a rotatable sample plate.

20. An analyzer for analyzing a fluidic sample, in particular to be injected into a mobile phase, wherein the analyzer comprises at least one sample transport device according to a sample transport arrangement according to claim 8.
